(19) United States
(12) Patent Application Publication
(10) Pub. No.: US 2008/0163656 A1
(43) Pub. Date: Jul. 10, 2008

(54) Identifiers for keys permitting visual, low-light and tactile recognition

(76) Inventor: Tse Wen Chang, Taipei (TW)

Correspondence Address: ERIC P. MIRABEL, 35 TECHNOLOGY DRIVE, SUITE 100, WARREN, NJ, 07059, US

(21) Appl. No.: 11/620,222

(22) Filed: Jan. 5, 2007

(51) Int. Cl. E05B 19/04

(52) U.S. Cl. 70/408

(57) ABSTRACT

Disclosed is a method of swiftly identifying by touch or sight (including in low light) different keys in a set. Different keys are tagged with protrusions from their surface, and identifiers for different keys may differ in the total number of protrusions (which can vary in arrangement patterns in accordance with the number of protrusions), the shapes of the protrusions, and/or the color of the protrusions. The protrusions are fluorescent to allow identification in low light or dark. The set of protrusions for each key can be adhered to the key by placing them on one side of a support strip, which is coated with adhesive on the other side.

### FIELD OF INVENTION

The invention relates to identifiers for individual keys in a set.

### BACKGROUND

In modern societies, most people carry a number of keys for locking and unlocking their homes and cars, as well as their mailboxes, file cabinets and safes where they keep their valuable or private belongings. The keys generally have different sizes and shapes and from experience, users of the keys eventually remember which key pairs with which lock. Quite often, however, a user cannot swiftly identify the keys to unlock or lock, either due to lack of recall, low light, visual impairment, or because different keys look alike.

The user can assist the matching recognition process by arranging the keys in a certain order on a key ring or a key holder. Sometimes, people mark their keys with ink pens of different colors, so that they differentiate the keys more readily, especially if the keys look alike. Users also stick small pieces adhesive paper tape on the top parts of the keys and mark the tape. Some manufacturers provide key tags, which the users attach to keys through holes in the non-mechanical parts of the key. The key tags are then marked, often by noting the objects the keys unlock.

A number of disclosures relate to the management or identification of keys, including some relating to labeling of keys using tags that hand through the holes in keys (U.S. Pat. No. 4,425,772; US Publication No. 2005/0016040 A1, Howard, Raymond, W.). Another disclosure relates to the labeling and monitoring of large numbers of keys, using adhesive tags of different colors and different planar shapes (or different patterns on such planar shapes) and an indicia system on a reference sheet for matching colors and shapes to the keys (US Publication No. 2003/0188467 A1, Truelsen, Thomas E.). Some design patents relate to the ornamental design of key tags, which bear mostly aesthetic value (US No. D439,037 S, Kebarian, Jack N.; US No. D456,852 S, Maloney, William, C.). Other patents relate to the design of key rings or key holders (U.S. Pat. No. 5,291,768, Rieffel, Robert and Vogeli, Earnest), while yet other relate to devices, electronic or mechanical systems or computers for managing the identification of large numbers of keys (U.S. Pat. No. 4,133,195. McLaren, Michael J.; U.S. Pat. No. 5,232,528. Reznickenko, Yury, et al.).

Notwithstanding these various tagging procedures, there is a need for an identifier which can be easily viewed in low light, and/or which can be identified by touch. These features allow key identification by the visually-impaired, and allow users to identify keys in dark or low light. This can significantly enhance security for the user, where one is attempting to quickly open the entrance to a home or car in a potential threat situation. Additionally, quick key identification may enhance health, e.g., for a patient needing to gain access to a locked medicine for acute treatment, or one needing to drive quickly to the hospital for acute medical care.

### SUMMARY

The invention relates to coded identifiers, which can be adhered to keys, which permit identification of keys visually, in low-light conditions, or by touch. Most people have, including their personal and work-related keys, fewer than ten keys. The identifiers described herein require only limited visual acuity, are coded for fast and easy recognition and can be identified in low-light or by touch only.

Different sets of such tag identifiers identify individual keys in a set. The identifiers include a set of protrusions from a surface of the key, and identifiers for different keys may differ in the total number of protrusions, the shapes of the protrusions, and/or the color of the protrusions.

The set of protrusions for each key can be adhered to the key by placing the protrusions on one side of a support strip that is coated with adhesive on the other side. The strip is preferably placed on the portion of the key that does not enter the lock, to avoid interference with its mechanical function. In one embodiment, a set of identifiers includes up to five individual hemi-spherical or conical-shaped protrusions (with more protrusions of different shapes also possible), which can be individually colored red, yellow, green, blue, and violet (in accordance with the other of the colors in a rainbow, for easier recall) or otherwise colored, to enhance recognition or to multiply the number of combinations for additional keys. The protrusions may fluoresce to enhance identification in low light or darkness.

The protrusions can be arranged with respect to each other as a lone protrusion (for one), side-by-side (for two), in a triangular pattern (for three), in a square formation (for four), and in cross or an “X” shape (for five), or in other patterns, as desirable or where additional protrusions are present. The strip the protrusions reside on can be any shape, including round or square, and may be shaped to correlate with the shape of the protrusions it bears, such as a round strip for hemispherical protrusions and a square strip for conical protrusions.

### BRIEF DESCRIPTION OF THE DRAWINGS

FIG. 1 depicts stick-on support strips for key coded identification, where the encoding is by the numbers of protrusions, the colors of the protrusions and the shapes formed of the protrusions. The identifier system can include fluorescence to permit low-light or dark viewing. The identifier system can include fluorescence to permit low-light or dark viewing. A transparent plastic case is included which houses a decoder (typically, a marked piece of paper).

FIG. 2 depicts different arrangements of the differently colored and shaped protrusions, sitting on top of round or square strips, with exemplary dimensions indicated.

FIG. 3 is a plan view of exemplary identifiers, in exemplary arrangements.

FIG. 4 depicts that in this example, the heights of the cones and hemi-spheres are one half of the diameters thereof, and an exemplary thickness for the strip is indicated.

FIG. 5 depicts fluorescent identifiers.

FIG. 6 depicts the decoder and transparent case for it, marked with symbols to readily identify conical or hemi-spherical identifiers.

### DETAILED DESCRIPTION

FIG. 1 shows stick-on labels 10-14 (support strips) for coded key identification, where the encoding is by the numbers of protrusions (e.g., protrusion 9), the colors of the protrusions in combination with the number of protrusions, and/or the shapes formed by the arrangement of the protrusions on the keys (which aids in identifying the number of protrusions on each key). The identifier system can include fluorescence to permit low-light or dark viewing. A transparent plastic case 16 is included and attached to the keys. Case 16 houses a decoder 18 (typically, an inked piece of paper, which indicates which arrangement of protrusions and colors correspond with which key).

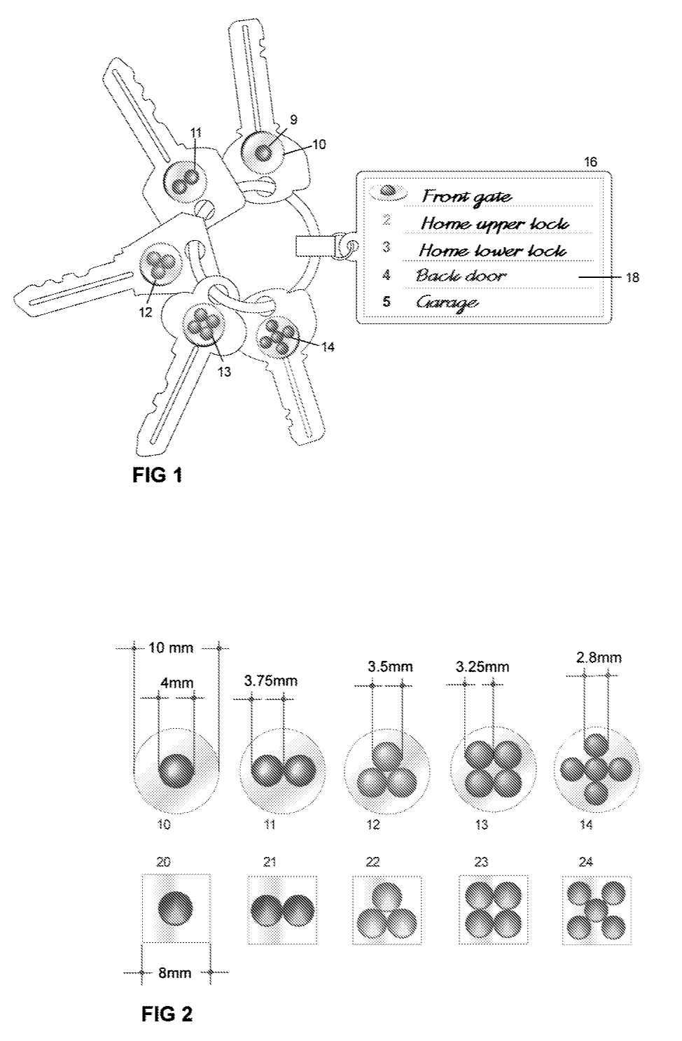

FIG. 2 depicts exemplary arrangements of strips 10-14, labels 20 to 24, and their respective protrusions. The strips can be different shapes and sizes (with exemplary dimensions shown). For example, where the strip is circular, it is 10 mm in diameter, and if square-shaped it is 8 mm×8 mm, and in either case it is about 1 mm thick. On the strips with 1 hemisphere, the hemispheres are e.g. 4 mm in diameter; on the strips with 2 hemispheres, each is about 3.75 mm in diameter; on the strips with 3 hemispheres, each is about 3.5 mm in diameter; on the strips with 4 hemispheres, each is about 3.25 mm in diameter; on the strips with 5 hemispheres, each is about 3 mm in diameter. The pattern of the hemispheres, where there is more than one hemisphere per strip, can be as shown, and the hemispheres can be arranged with respect to each other such that they are in contact at their respective edges.

The particular arrangements of protrusions in the respective strips 10-14 and 20-24 facilitate visual and tactile recognition, as one can swiftly and easily see or feel the difference between different protrusion patterns in each of the labels. However, other arrangements are also possible. Different colors of the protrusions can also be used, to provide additional coding or to facilitate visual recognition of different patterns. The protrusions can be different shapes e.g., hemi-spherical or conical.

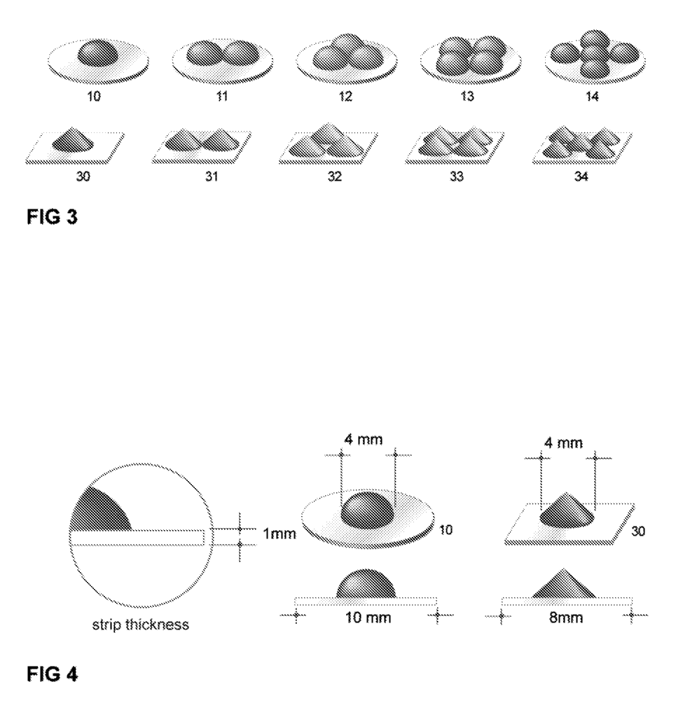

FIG. 3 shows strips 30 to 34 with conical-shaped protrusions. Other shapes are also possible. Differently shaped protrusions allow encoding of additional keys, or different shapes can be used as needed, to provide more ready code recognition. FIG. 4 shows exemplary dimensions for the strips and the protrusions. In one embodiment, for ready visual and tactile recognition of the encoding, the diameter of the hemi-spherical or conical protrusions is twice their height.

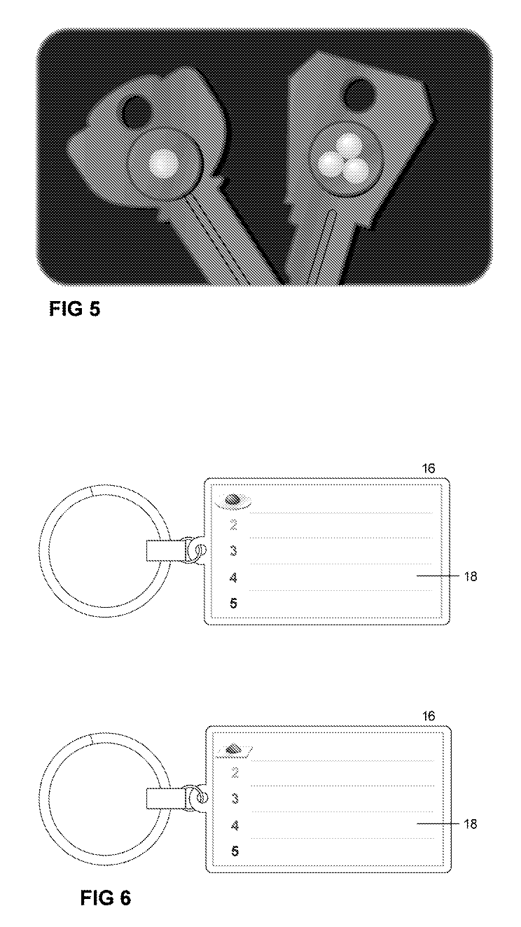

As shown in FIGS, 1, 2 and 3, where 5 keys are encoded, five protrusions are preferably used for encoding, and for encoding additional keys, two or more sets of tags with distinctive features (shapes, colors, patterns or size) can be used. The protrusions can be any of a number of colors, with one arrangement of five protrusions being that the individual protrusions are red, yellow, green, blue, and violet, respectively; it in order of the colors in a rainbow. As shown in FIG. 5, the protrusions can also fluoresce (e.g. in green), such that they can be seen better in dim light or dark.

Suitable materials for the protrusions include plastic or rubber—relatively firm and/or slightly flexible. Suitable materials for strips are flexible, like conventional tape, so it can tightly adhere to a non-uniform key surface. The surface of the strips bearing the adhesive is preferably coated with a releasable piece of thin film or paper, which can be peeled off before adhering the strips to the keys.

Plastic case 16 is preferably formed from two clear plastic sheets that can be snapped together to form the case. The case 16 should be sized so that the code on sheet 18 can be easily read, in one embodiment, the case 16 is about 3 cm×4 cm.

Sheet 18 allows decoding of the keys. As shown, along the left margin of sheet 18 is an image of a hemisphere (e.g., red in color) and the round strip it is mounted on, and the numbers “2 (in yellow)”, “3 (in green)”, “4 (in blue)”, and “5 (in violet),” and to the right side of these images are lines with blank spaces for noting in writing the locks with which the keys are paired. The other side of sheet 18 (not shown), is the same, except the red hemisphere and its round strip is replaced by a red cone and its square strip. The sheet 18 is sized to fit into the case 18. Two sets of five keys can be encoded with such a system.

It should be understood that the terms, expressions and examples used herein are exemplary only, and not limiting, and that the scope of the invention is defined only in the claims which follow, and includes all equivalents of the subject matter of the claims.

1. A method of encoding a set of keys for visual or tactile recognition, comprising:
adhering each key in the set a planar strip having one a plurality of protrusions on one of its planar surfaces, each protrusion having a distinct shape, said protrusion shapes being capable of being distinguished by touch, wherein different keys are encoded with differently shaped protrusions, wherein said protrusions are differently colored on different keys and/or different keys have different numbers of protrusions.

2. (canceled)

3. The method of claim 1 wherein the protrusions fluoresce to allow visual detection of the number, color and shape of the protrusions in low light or dark.

4. The method of claim 1 further including a decoder with the set of keys, said decoder capable of being used to identify encoded keys by their function in a tangible medium of expression.

5. (The method of claim 4 wherein the tangible medium of expression is inked paper.

6. The method of claim 1 wherein the protrusions are hemispherical or conical configuration.

7. The method of claim 6 wherein the protrusions have a height of one-half their diameter.

8. The method of claim 1 wherein the protrusions are mounted on support strips having adhesive on one side thereof, which are adhered to the keys.

9. The method of claim 8 wherein the planar strips bearing differently shaped protrusions are differently shaped.

10. The method of claim 9 wherein planar strips bearing hemispherical protrusions are circular and strip supports bearing conical protrusions are square.

11. The method of claim 1 wherein five keys are provided with planar strips having one, two, three, four and five protrusions, respectively.

12. The method of claim 1 wherein in a set of ten keys, five keys in the set are provided with planar strips having one, two, three, four and five conical protrusions, respectively, and the other five keys in the set are provided with planar strips having one, two, three, four and five hemispherical protrusions, respectively.

13. The method of claim 12 wherein protrusions are red on the keys with one protrusion, yellow on the keys with two protrusions, green on the keys with three protrusions, blue on the keys with four protrusions, and violet on the keys with five protrusions.

14. The method of claim 12 wherein the keys having two have the protrusions arranged side-by-side, the keys having three protrusions have the protrusions arranged in a triangular pattern, the keys having four protrusion have the protrusions arranged in a square pattern, and the keys having five protrusions have the protrusions arranged to form an “X” shape.

15. The method of claim 14 wherein the X shaped is form with one protrusion at the intersection of the arms and one protrusion at each vertex.

16. The method of claim 13 wherein the red protrusion's diameter is 4 mm, the yellow protrusions' diameters are 3.75 mm, the green protrusions' diameters are 3.5 mm, the blue protrusions' diameters are 3.25 mm, and the violet protrusions' diameters are 2.8 mm.

17. The method of claim 10 wherein the circular planar strips hearing hemispherical protrusions have a diameter of 10 mm and a thickness of 1 mm.

18. The method of claim 10 wherein for the square planar strips bearing conical protrusions, the length of each side of the square is 8 mm with a thickness of 1 mm.

19. A set of identifiers for encoding a key set for visual or tactile recognition, comprising:
a planar strip having a plurality of protrusions on one of its planar surfaces, each protrusion having a distinct shape, said protrusion shapes being capable of being distinguished by touch, wherein different keys are encoded with differently shaped protrusions, and wherein said protrusions are differently colored on different keys and/or different keys have different numbers of protrusions.

20. (canceled)

21. The set of identifiers of claim 19 wherein the protrusions fluoresce to allow visual detection of the number, color and shape of the protrusions in low light or dark.

22. The set of identifiers of claim 19 wherein the protrusions are hemispherical or conical in configuration.

23. The set of identifiers of claim 22 wherein the height of the protrusions is one-half their diameter.

24. The set of identifiers of claim 19 wherein the strips have adhesive on one side thereof to adhere to keys.

25. The set of identifiers of claim 24 wherein the strips bearing differently shaped protrusions are differently shaped.

26. The set of identifiers of claim 22 wherein strips bearing hemispherical protrusions are circular and strips bearing conical protrusions are square.

27. The set of identifiers of claim 19 wherein five strips bear one, two, three, four and five protrusions, respectively.

28. The set of identifiers of claim 19 wherein five strips bear one, two, three, four and five conical protrusions, respectively, and five strips bear one, two, three, four and five hemispherical protrusions, respectively.

29. The set of identifiers of claim 28 wherein protrusions are red on the strips with one protrusion, yellow on the support strips with two protrusions green on the strips will three protrusions, blue on the strips with four protrusions, and violet on the strips with five protrusions.

30. The set of identifiers of claim 28 wherein the strips having two protrusions the protrusions arranged side-by-side, the strips having three protrusions have the protrusion arranged in a triangular pattern, the strips having four protrusions have the protrusions arranged in a square pattern, the strips having five protrusions have the protrusions arranged to form an “X” shape.

31. The set of identifiers of claim 30 wherein the X shaped is formed with one protrusion at the intersection of the arms and one protrusion at each vertex.

32. The set of identifiers of claim 29, wherein the red protrusion's diameter is 4 mm, the yellow protrusions' diameters are 3.75 mm, the green protrusions' diameters are 3.5 mm, the blue protrusions' diameters are 3.25 mm, and the violet protrusions' diameters are 2.8 mm.

33. The set of identifiers of claim 26 wherein the diameter of the strips bearing hemispherical protrusions is 10 mm with a thickness of 1 mm.

34. The method of clam 26 wherein, for the square strips bearing. conical protrusions, the length of each side of the square is 8 mm with a thickness of 1 mm.

35. A kit for encoding a key set of for visual or tactile recognition, comprising:
a planar strip having a plurality of protrusions on one of its planar surfaces, each protrusion having a distinct shape, said protrusion shapes being capable of being distinguished by touch, wherein different keys a encoded with differently shape protrusions, and said protrusions are differently colored on different keys and/or different keys have different numbers of protrusions; and
a decoder adapted to be marked to identify encoded keys in accordance with the planar strip attached thereto.

36. The kit of claim 35 wherein the decoder is paper or other tangible medium of expression housed in a transparent case.
